(19) United States
(12) Patent Application Publication
(10) Pub. No.: US 2007/0020360 A1
(43) Pub. Date: Jan. 25, 2007

(54) Package made of a plastic film

(75) Inventors: Peter Wilhelmus Henricus Rietjens, Magnoliastraat (NL); Matthias Giebel, Wardenburg (DE)

Correspondence Address: PERMAN & GREEN, 425 POST ROAD, FAIRFIELD, CT, 06824, US

(73) Assignee: CFS WEERT B.V., NL-6000 AG WEERT (NL)

(21) Appl. No.: 10/563,790

(22) PCT Filed: Jul. 5, 2004
(86) PCT No.: PCT/EP04/07325

§ 371 Date: Jun. 15, 2006

(30) Foreign Application Priority Data
Jul. 4, 2003 (EP) 03015185.6

(51) Int. Cl. A23B 7/148

(52) U.S. Cl. 426/106

(57) ABSTRACT

The package according to the invention is mainly made from transparent or partially transparent or intransparent, especially multilayer films (seal layer/barrier layer), the film including opening means and a residual bag, whereas the residual bag has the shape of an envelope after the opening means have been removed.

The package according to the invention is mainly made from transparent or partially transparent or intransparent, especially multilayer films (seal layer/barrier layer), said film comprising opening means and a residual bag, whereas the residual bag has the shape of an envelope after the opening means have been removed.

Packages of are nowadays often used to sell foodstuff. Since in most cases the contents of the package it not used at once after the initial opening, it is preferable to that the bags are reclosable.

The object of the present invention is to provide a reclosable package.

The object is solved with the package according to the independent claim 1. Preferred embodiments of the packaging and the method are claimed in the independent claims.

It could not have been expected and was totally surprising for a person skilled in the art that receive an envelope type package that was originally rectangular. The package is opened easily and reclosable.

The packaging according to the invention is mainly made from transparent or partially transparent, partially opaque and/or coloured plastic films. These films are preferably multilayer films with at least one sealing layer and/or one barrier layer. The sealing layer allows to seal parts of film together for example by applying heat and/or pressure. The barrier layer reduces the migration of gaseous substances through the film, for example oxygen into the packaging and water vapour from the packaging. The plastic film according to the invention can be provided as a wrapping and can be produced on wrappingpers, especially horizontal wrappingpers.

In a preferred embodiment of the present invention, the package comprises a scoring that is located between the residual bag and the opening means. The scoring can be produced for example with a laser or a punch.

Preferably, the scoring does not extend through the barrier-layer, so that the penetration of gases through the film is reduced even though the film is scored. Even more preferred, the scoring does not harm the sealing layer.

In a preferred embodiment of the present invention, the package comprises a flap which allows to reclose the package easily. Even more preferred, outside of the wrapping an adhesive is provided that allows to attach the flap to the wrapping, in order to reclose the package.

Preferably, the package comprises, except the wrapping, a tray carrying the goods, especially slices of food, e.g. slices of cheese, ham etc. The tray functions also as a mechanical stabiliser of the packaging so that the packaging maintains its shape, which improves the esthetical aspects of the packaging. More preferably, the tray and/or the wrapping have means to limit the extent of removal of the tray from the wrapping.

The invention will be explained in more detail below with reference to the appended drawings 1-4, in which:

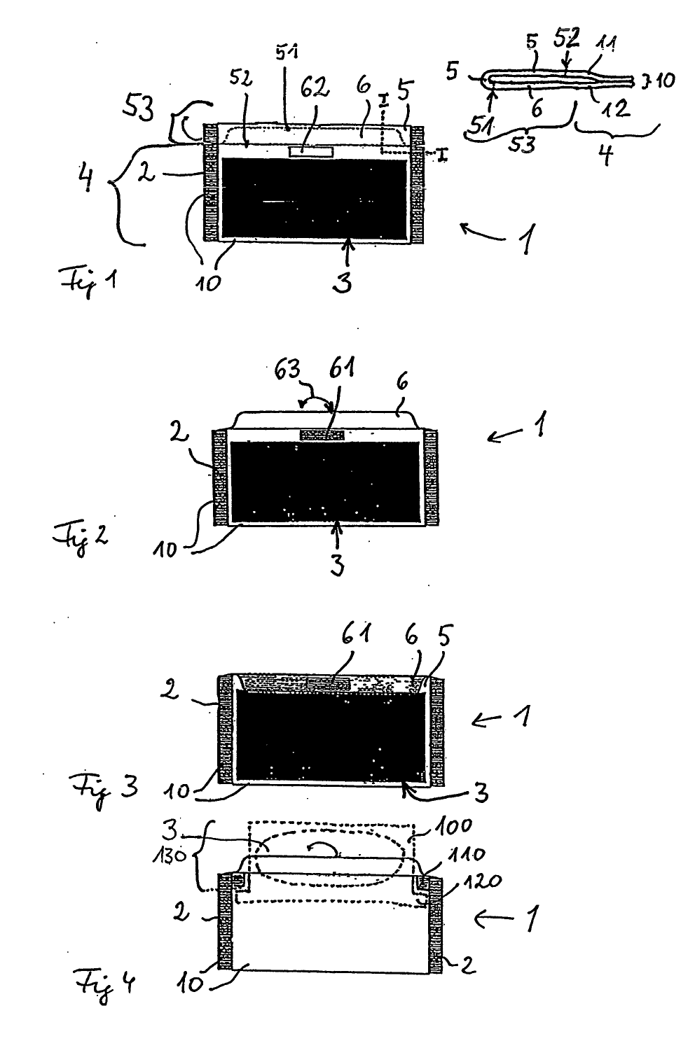

FIG. 1 shows the closed inventive package

FIG. 2 shows the opened package according to FIG. 1

FIG. 3 shows the reclosed package according to FIG. 1 or 2

FIG. 4 shows the inventive package with a removed tray

In FIG. 1, an embodiment of a package 1 according to the invention is schematically shown, whereas the package 1 comprises a plastic film 10 with two seals 2 at the sides and one seal at the bottom and opening means 5 as well as the residual bag 4. The film 10 encloses packaged goods 3. In FIG. 1, the package 1 is shown in its initially closed state. On the right side of FIG. 1, an enlarged cross-section following the line I-I through an opening area 53 of the closed package 1 is shown. The film 10 is folded and thus comprises layers 11 and 12. In the opening area 53 the opening means 5 are separated from the residual bag 4 by a first scoring 51 in the lower layer 12 and a second scoring 52 in the upper layer 11. The scorings 51, 52 are provided as laser cuts, especially U-type laser cuts and extent through the entire width of the package. The scorings 51, 52 do not extend through the entire film, respectively, i.e. they do not cut through the upper film 11 or the lower film 12 completely, so that initially the package 1 is hermetically sealed or closed and an existing barrier layer is still intact. The scorings 51, 52 are provided such that they are, at least in a part of the opening area 53, not facing each other, as depicted in the enlarged detail on the right side of FIG. 1. Thus, it is ensured that by initially removing, i.e. separating, the opening means 5 from the residual bag 4 along the scorings 51, 52, there still remains a closing means 6, especially a flap 6, as part of the residual bag 4 and according to the invention as part of the film 10. With the closing means 6, it is possible to re-close the package 1 after the initial opening.

In FIG. 2 the package 1 with the film 10, the goods 3, the seals 2 and the closing means 6 is depicted in its state after removal of the opening means 5. The package is opened by pulling away the opening means along the scorings 51 and 52. According to an advantageous embodiment of the invention, there is provided an adhesive 61 on the side of the film 10 which is opposite the closing means 6. The closing means 6 can therefore be folded towards the adhesive 61 and thereby reclose the package 1. This closing and reopening is indicated by an arrow 63 in FIG. 2. The person skilled in the art understands that the closing means 6 can be opened and closed a often as desired. In an advantageous embodiment of the invention, the adhesive 61 is provided with a tape 62 which is shown in FIG. 1, covering the adhesive 61. The adhesive 61 is only effective after removing the tape 62 from it.

The reclosed package 1 with the folded closing means 6 towards the adhesive 61 is shown in FIG. 3. In an alternative embodiment which is not shown in the figures, the closing means 6 are not glued to an adhesive but are simply inserted into the opening of the residual bag 4 between the upper and lower film 11, 12 such that a reclosure of the package 1 is achieved. In any case, the closing means 6 are advantageously provided in the form of an “envelope like” flap 6.

In FIG. 4, an advantageous embodiment of the invention is shown, where the initially opened (or re-opened) package 1 with the film 10 and the seals 2 comprises a tray 100 for carrying goods 3. The tray 100 is provided slidablely inwards and outwards preferably only until a certain extent. Thus, in the advantageous embodiment of FIG. 4, there are provided means 110, 120 to prevent the tray 100 together with the goods 3 of being completely pulled-out of the package 1, i.e. pulled-out of the residual bag 4. This is achieved by a seal portion 110, which interacts with dents 120 of the tray 100 to prevent a complete pulling-out of the tray 100 from the package 1. By the interaction of these means, the tray 100 is prevented from being completely unbaged. Therefore, the tray 100 can only be removed partially, i.e. up to a predetermined maximum extend 130 of, e.g. 80% or 90% or 95%, depending especially to the mechanical strength of the dents 120 of the tray 100 and the usual force applied by the user of the package 1 to pull out the tray 100 from the package 1. Means 120 also serve as guiding means for the motion of the tray in the package. Due to means 110, 120, the tray can be reinserted into the package 1 easily, because insertation of the tray into the bag is not needed and the the movement of the tray in the bag is guided.

1. Package (1) made of a plastic film (10), said film (10) comprising opening means (5) and a residual bag (4), characterized in, that the residual bag (4) has the shape of an envelope after the opening means (5) have been removed.

2. Package according to claim 1, characterized in, that a scoring (51, 52) is located between the residual bag (4) and the opening means.

3. Package (1) according to any one of the preceding claims, characterized in that said scoring (51, 52) is provided as a laser-scoring.

4. Package according to anyone of the preceding claims, characterized in, that it comprises a flap (6) to reclose the package after removal of the opening means.

5. Package (1) according to any one of the preceding claims, characterized in that an adhesive (61) is provided on the outside of the film (10).

6. Package (1) according to any one of the preceding claims, characterized in that said adhesive (61) interacts with the flap (6) in order to re-close the package (1).

7. Package (1) according to any one of the preceding claims, characterized in that said film (10) encloses a tray (100), whereas said package (1) and said tray (100) comprise means (110, 120) to limit the removal of said tray (100) from said package (1) only up to a predetermined maximum extent.

8. Package (1) according to any one of the preceding claims, characterized in that said tray (100) is provided to carry packaged goods (3).

9. Package (1) according to any one of the preceding claims, characterized in that said packaged goods (3) are only removed partially up to a predetermined maximum extent.

10. Package (1) according to any one of the preceding claims, characterized in that said plastic film (10) is provided as a multilayer film (10).

11. Package (1) according to any one of the preceding claims, characterized in that said packaged goods (3) are cheese and/or ham.
